(19) United States
(12) Patent Application Publication
(10) Pub. No.: US 2011/0217045 A1
(43) Pub. Date: Sep. 8, 2011

(54) CROSSTALK MITIGATION IN OPTICAL TRANSCEIVERS

(75) Inventors: Christopher Watson, Ottawa (CA); Michael Vitic, Chelsea (CA)

(73) Assignee: ONECHIP PHOTONICS INC., Ottawa (CA)

(21) Appl. No.: 12/715,653

(22) Filed: Mar. 2, 2010

(51) Int. Cl. H04J 14/02

(52) U.S. Cl. 398/79

(57) ABSTRACT

The invention relates to a method of improving the performance of optical receivers within optical transceivers by compensating for crosstalk, both optical and electrical. Optical crosstalk may arise within the optical receiver from a variety of sources including directly from the optical emitter within, indirectly from the optical emitter via losses, and losses of other received wavelengths within the optical transceiver coupled to the optical receiver. Electrical crosstalk may arise for example between the electrical transmission lines of the optical transmitter and optical receiver. The method comprises providing a secondary optical receiver in predetermined location to the primary optical receiver, the optical receivers being electrically coupled such that the crosstalk induced photocurrent in the secondary optical receiver is subtracted from the photocurrent within the primary optical receiver. The method may be applicable to either monolithic and hybrid optical transceivers.

### FIELD OF THE INVENTION

This invention relates to optical transceivers and more specifically to mitigating optical and electrical crosstalk within such optical transceivers.

### BACKGROUND OF THE INVENTION

Deep penetration of optical fiber into access networks requires an unparalleled massive deployment of optical interface equipment that drives the traffic to and from users. For example, optical transceivers, which receive downstream signals on one wavelength and send upstream signals on another wavelength, both wavelengths sharing the same optical fiber, have to be deployed at every optical line terminal (OLT), optical network unit (ONU), or optical network terminal (ONT). Therefore, cost efficiency and volume scalability in manufacturing of such components are increasingly major issues. It is broadly accepted within the telecommunication industry that optical access solutions are not going to become a commodity service, until volume manufacturing of the optical transceivers and other massively deployed optical components reaches the cost efficiency and scalability levels of consumer products.

Within a framework of the current optical component manufacturing paradigm, which is based mainly on bulk optical sub-assemblies (OSA) from off-the-shelf discrete passive and active photonic devices, the root cause of the problem lies in a labor-intensive optical alignment and costly multiple packaging. Not only do these limit the cost efficiency, but they also significantly restrict the manufacturer's ability to ramp production volumes and provide scalability in manufacturing. The solution lies in reducing the optical alignment and packaging content in the OSA and, eventually, replacing the optical assemblies with photonic integrated circuit (PIC) technologies, in which all the functional elements of optical circuit are monolithically integrated onto the same substrate. Then, the active optical alignment by hand is replaced by automated passive alignment, defined by means of lithography, and multiple component packaging is eliminated altogether, enabling automated and volume-scalable mass production of the complex optical components, based on existing planar technologies and semiconductor wafer fabrication techniques.

In the context of applications, the materials of choice for either monolithic PICs or the sources/receivers for use in the optical transmission systems remain indium phosphide (InP) and its related III-V semiconductors. In monolithic PICs these materials, uniquely, allow for active and passive devices operating in the spectral ranges of interest for optical telecommunications to be combined onto the same InP substrate. In particular, InP PICs, perhaps, are the best hope for a cost-efficient and volume-scalable solution to the most massively deployed components: optical transceivers for the access passive optical networks operating in the 1.3 μm and 1.5 μm wavelength ranges, see for example V. Tolstikhin (“Integrated Photonics: Enabling Optical Component Technologies for Next Generation Access Networks”, Proc. Asia Optical Fiber Communication & Optoelectronic Exposition & Conference, October 2007).

Within every optical transceiver is an optical photodetector which converts the received optical signal to an electrical signal allowing for this received signal to be provided to the electrical equipment connected to the telecommunications network, be this a telephone with Voice-over-IP (VOIP), a computer, or a digital TV set-top box for example. Such photodetectors are designed as either PIN diodes with low reverse voltage bias, having a wide, lightly doped ‘near’ intrinsic semiconductor region between a p-type semiconductor and an n-type semiconductor region, or as avalanche photodiodes (APD) with high reverse voltage bias. Compatibility of PIN diodes with standard electronics, for example CMOS and bipolar CMOS, with typical reverse bias voltages being a few Volts rather than many tens of Volts with APDs, low capacitance, and high bandwidth operation have made PIN diodes the preferred choice in network deployments.

Additionally within every optical transceiver is an optical emitter which converts transmit electrical signals to an optical signal allowing for this transmit signal to be provided from electrical equipment connected to the telecommunications network, be this a telephone with Voice-over-IP (VOIP), a computer, or a digital TV set-top box for example. Such optical emitters are designed as PIN diodes with low forward voltage bias, having a wide, lightly doped ‘near’ intrinsic semiconductor region between a p-type semiconductor and an n-type semiconductor region. Such emitters may include according to the requirements of the optical network to which they are interfaced include, for example, light emitting diodes (LEDs), superluminescent light emitting diodes (SLEDs), Fabry-Perot laser diodes, or distributed feedback laser diodes (DFBLD). Such optical emitters may further be directly modulated or externally modulated according to the requirements of the optical network in respect of data rate, dispersion management etc.

As discussed supra PICs are the best hope to achieve the cost-efficient and volume-scalable solution required for access network transceivers. In a monolithic PIC, the PIN diode is implemented within a waveguide structure resulting in waveguide photodetectors (WPD) and optical emitter devices (OED) which are compatible with the passive waveguide circuitry of PICs and thereby facilitate the monolithic integration of the photodetectors with passive wavelength demultiplexing and routing elements. Accordingly, the requirements for PIC-compatible, high-performance and yet inexpensive PIN WPD and PIN OED are further advanced and essential for this optical fiber penetration into the subscriber customer base and resulting PIC penetration into the access communication systems.

Whilst the motivation for implementing such PIN WPD and PIN OED structures within monolithic PIC solutions are particularly evident within access networks it should be understood that they are generic devices that are attractive for any optical transceiver whether it is monolithically integrated or is integrated as a hybrid using discrete semiconductor die in conjunction with a passive PIC element for routing and multiplexing.

However, in any implementation of an optical transceiver, performance degradation is evident in the receiver channel or channels as a result of crosstalk within the optical transceiver. Sources of crosstalk may be either optical or electrical in origin and be associated with either other active elements, such as photodetectors and emitters, or with passive elements, such as wavelength multiplexers, optical interfaces etc, or ancillary elements such as electrical transmission lines, transimpedance amplifiers etc. Within the prior art attention in respect of PIC solutions, be they hybrid or monolithic, has focused to addressing discrete elements within the circuit. Examples of such elements include wavelength multiplexers, spot-size converters to improve coupling losses to and from the optical fiber interface of the optical network, transitions between optical elements such as replacing butt-coupled interfaces with multiple vertical guide transitions (see for example V. Tolstikhin et al. in “Optically Pre-Amplified Detectors for Multi-Guide Vertical Integration in InP” (Proc. Indium Phosphide and Related Materials 2009, pp. 155-158, Newport Beach, 2009), etc.

Despite considerable research and development by multiple research groups worldwide together with commercial deployments of optical transceivers within a wide range of networks including BPON, EPON, GPON, LAN, WAN, long-haul there is still a commercially driven demand for improved performance of such optical transceivers. Whether such demands are increased span length, increased split ratio, or increased deployment tolerances, the overall result is a pressure to reduce the minimum optical input power to the receiver without sacrificing the bit-error rate performance (BER).

Within the receiver channel the received optical bits are converted to the electrical domain by the photodetector, before being at least one of amplified, limited, thresholded by transimpedance amplifiers (TIAs), limiting amplifiers and decision circuits respectively. The bit-error rate being the determination of a bit as being at an incorrect level, i.e. the bit being a “1” or a “0”, divided by the number of bits determined. Typically optical networks are specified in respect of the minimum optical power required to achieve a BER equivalent of one error in a billion bits received (1 in 1,000,000,000 or 10⁻⁹) or at one error in a trillion bits received (1 in 1,000,000,000,000 or 10⁻¹²). The majority of developments within optical transceivers to date have sought to reduce the insertion loss, which includes both optical and transduction losses, between the optical network and the receiver so that received signals are not wasted, so to speak.

Amongst such developments are those seeking to address a key performance parameter of any photodetector, namely its responsivity, defined as induced photocurrent relative to incident optical power. It is measured in Amp/Watt (A/W) and can be represented as R=η(e/ω), where R is the overall quantum efficiency, e is the electron charge and ω is the photon energy. Whereas the value of η in an on-chip PIN WPD, which greatly depends on the device design, can reach a respectable 70%, see for example V. Tolstikhin, “One-Step Growth Optical Transceiver PICs in InP” (Proc. ECOC 2009, Sep. 20-24 2009, Paper 8.6.2), still it is always less than unity and hence the responsivity of any PIN detector is fundamentally lower than e/ω. Accordingly to achieve an overall quantum efficiency η>1, some form of gain must be added between the incoming signal from the optical fiber and the receiver electrical circuit which may be electrical gain after detection, e.g. using a phototransistor where the signal is amplified once it is already in the electrical domain or optical gain before detection employing a semiconductor optical amplifier/ These solutions increase the received optical signal thereby potentially increasing signal-to-noise ratio of the signal at the receiver thereby opening the received “eye” for the decision circuitry and thereby signal-to-noise ratio (SNR).

However, such elements increase the complexity of the optical implementations of the transceiver circuit thereby reducing yield and increasing cost. Further as taught by V. Tolstikhin et al in “Optically Pre-Amplified Detectors for Multi-Guide Vertical Integration in InP” (Proc. Indium Phosphide and Related Materials 2009, pp. 155-158, Newport Beach, 2009) the addition of an optical amplifier in the receiver path may reduce SNR if the optical amplifier is not wavelength filtered such that noise contributions from ASE are removed from outside the intended wavelength range of the receiver channel. Such wavelength filtering in combination with the semiconductor optical amplifier further increasing manufacturing complexity and thereby cost of the final optical transceiver.

Such techniques to improving SNR do not address the contributions of noise that arise from a multitude of other sources within the optical transceiver. These can arise from a variety of sources including for example optical coupling from the optical transmitter to the optical receiver. Such coupling may arise from optical paths that are for example non-guided wherein emitted signals from the optical transmitter which are not coupled to the output having been subject of losses at waveguide interfaces, other circuit elements, etc are coupled to the optical receiver having been confined within either the PIC or integrated optical circuit forming part of a hybrid integrated optical transceiver. Such unintended optical coupling can occur along a variety of paths including direct line of sight, scattering and reflection. For example, optical emissions from the optical transmitter can be coupled into the substrate through unavoidable processes including but not limited to spontaneous emissions, radiation losses (for example a high order loss coupled distributed feedback laser), or scattering from the waveguides of the optical transmitter, and then into the optical receiver after multiple total reflections within the substrate.

Other optical coupling may be guided arising from reflections/losses within the optical path from optical emitter to optical network and these reflections/losses being routed to the optical receiver with or without additional loss. Additionally crosstalk can arise from electrical sources wherein the high speed electrical signals supplied to the optical transmitter are coupled to the detector circuitry, which may be for example either simple electrical interconnects, provision of a transimpedance amplifier (TIA) in close association with the optical receiver, or provisioning of a TIA and limiting amplifier.

Irrespective of their origin such crosstalk contributions impact the overall noise and signal levels for the received signal for example by increasing the overall background signals within the photodetector. Alternatively such crosstalk from the optical transmitter to the optical receiver may manifest itself as noise within the current symbol, as inter-symbol interference, as jitter etc. Whilst electrical crosstalk will be modulated, arising from radiative coupling of the high speed data signals, optical crosstalk can be modulated and/or unmodulated. Even continuous wave emissions are of concern as these can corrupt the receiver's receive signal strength indicator (RSSI) and/or automatic gain control leading to desensitization.

Within the prior art researchers have addressed the issue of optical crosstalk from the substrate by means of surface treatments that are designed to release or absorb the optical signals arising from the optical transmitter. Electrical crosstalk is addressed by simply trying to increase the spacing between transmissions lines associated with the optical transmitter and optical receiver and/or applying screening. However, no general strategy has been suggested to mitigate the effects of other sources of electrical and optical crosstalk in monolithically integrated optical transceiver PICs or hybrid integrated optical transceivers, without increasing die footprint and/or processing complexity thereby increasing transceiver costs.

Accordingly it would be beneficial to provide a method for generating a second electrical signal for combination with the primary electrical signal from the optical receiver to mitigate these electrical and optical crosstalk contributions. The second electrical signal being predominantly the optical and electrical crosstalk signals and being generated from a second optical receiver within the optical transceiver.

### OBJECT OF THE INVENTION

The purpose of this invention is to provide a method of suppressing both optical and electrical crosstalk between the transmitter and receiver sections of either monolithically integrated optical transceiver PICs or hybrid integrated optical transceivers. The method of the invention exploits a novel receiver architecture that provides immunity from both optical and electrical transmitter crosstalk, and is particularly suited to monolithic integration.

### SUMMARY OF THE INVENTION

It is an object of the present invention to obviate or mitigate at least one disadvantage of the prior art.

This invention recognizes that that the cross talk signals induced in a channel depends upon the spatial position of the receiver for this channel in relation to source of the impairment. Thus, by deploying two pin detectors which, for example, are sited very close to one another, the cross talk signal (both electrical and optical) induced in the detectors will be nearly identical. Consequently, in a transceiver application, if one diode is used to detect the desired downstream signal, the second diode can provide a reference crosstalk signal that can be subtracted from the receiver channel to remove the effect of any crosstalk impairment. It is apparent that this procedure is effective in mitigating both optical and electrical crosstalk and does not depend upon whether the interference is modulated or continuous wave. It will be also apparent that the invention is not restricted to closely spaced detectors, or indeed, monolithic implementations of the transceiver, the intention is to engineer diodes with approximately identical behavior with respect to crosstalk impairments and use one as a reference to subtract the unwanted signal from the wanted signals that are received in the other channel.

In accordance with another embodiment of the invention there is provided a device comprising:
an optical input port in communication with an optical network for receiving and transmitting optical signals;
a wavelength multiplexer comprising a common port optically coupled to the optical input port and characterized by at least a first predetermined wavelength range, and two channel ports of a plurality of channel ports, each channel port characterized by at least a second predetermined wavelength range, each second predetermined wavelength range being within the first predetermined wavelength range;
an optical emitter coupled to the first channel port for transmitting an optical signal to the optical input port via the wavelength multiplexer, the optical emitter operating within the second predetermined wavelength range of the first channel port;
a first photodetector coupled to the second channel port of the wavelength multiplexer for receiving optical signals from the optical input port via the wavelength multiplexer and providing a first electrical signal; and
a second photodetector disposed in predetermined location relative to the first photodetector for providing a second electrical signal to be used in combination with the first electrical signal to improve a measure of the first electrical signal.

In accordance with another embodiment of the invention there is provided a device comprising:
an optical input port in communication with an optical network;
a wavelength multiplexer comprising a common port optically coupled to the optical input port and characterized by at least a first predetermined wavelength range, and at least one channel port of a plurality of channel ports, the channel port characterized by at least a second predetermined wavelength range, the second predetermined wavelength range being within the first predetermined wavelength range;
a first photodetector coupled to the one channel port of the wavelength multiplexer for receiving optical signals from the optical input port via the wavelength multiplexer and providing a first electrical signal; and
a second photodetector disposed in predetermined location relative to the first photodetector for providing a second electrical signal to be used in combination with the first electrical signal to improve a measure of the first electrical signal.

In accordance with another embodiment of the invention there is provided a method comprising:
providing an optical input port in communication with an optical network and for receiving and transmitting optical signals;
providing a wavelength multiplexer comprising a common port optically coupled to the optical input port and characterized by at least a first predetermined wavelength range, and at least one channel port of a plurality of channel ports, each channel port characterized by at least a second predetermined wavelength range, each second predetermined wavelength range being within the first predetermined wavelength range;
providing a first photodetector coupled to the one channel port of the wavelength multiplexer for receiving optical signals from the optical input port via the wavelength multiplexer and providing a first electrical signal; and
providing a second photodetector disposed in predetermined location relative to the first photodetector for providing a second electrical signal to be used in combination with the first electrical signal to improve a measure of the first electrical signal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an optical transceiver according to the prior art;

FIG. 2 illustrates a bidirectional optical transceiver according to the prior art to illustrate the optical and electrical cross-coupling mechanisms between the optical emitter and optical receiver within the bidirectional optical transceiver;

FIG. 3 illustrates a silica-on-silicon bidirectional optical hybrid transceiver according to the prior art;

FIG. 4 illustrates a monolithic bidirectional optical transceiver according to the prior art;

FIG. 5 illustrates an embodiment of the invention for a bidirectional optical triplexer exploiting a silica-on-silicon optical hybrid wherein additional optical photodetectors are provided and allow crosstalk correction of each of the dual receiver channels;

FIG. 6 illustrates an embodiment of the invention wherein the second compensating photodetector is implemented within the same multi-guide vertical integration structure behind the primary receiver photodetector;

FIG. 7 illustrates an embodiment of the invention wherein the second compensating photodetector is implemented adjacent the optical emitter in corresponding relation to the optical emitter as the primary receiver photodetector;

FIG. 8 illustrates an embodiment of the invention for connecting the primary and secondary photodetectors using a differential transimpedance amplifier to improve an aspect of performance of the primary receiver;

FIG. 9 illustrates an embodiment of the invention for connecting the primary and secondary photodetectors to improve an aspect of performance of the primary receiver employing a dual power supply and a transimpedance amplifier; and

FIG. 10 illustrates an embodiment of the invention for connecting the primary and secondary photodetectors to improve an aspect of performance of the primary receiver using a single power supply, a bias-Tee and a transimpedance amplifier.

### DETAILED DESCRIPTION

The present invention is directed to method of correcting a received signal from a primary photodetector with a correction signal derived from a secondary photodetector disposed in a predetermined relationship to the primary photodetector. The correction signal being substantially that of the primary photodetector minus the intended received signal for this primary photodetector, the secondary photodetector not receiving the intended received signal and thereby receiving only optical and/or electrical crosstalk. Accordingly combining the electrical signals from the primary and secondary photodetectors allows this crosstalk to be subtracted thereby improving the signal-to-noise ratio of the intended received signal.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

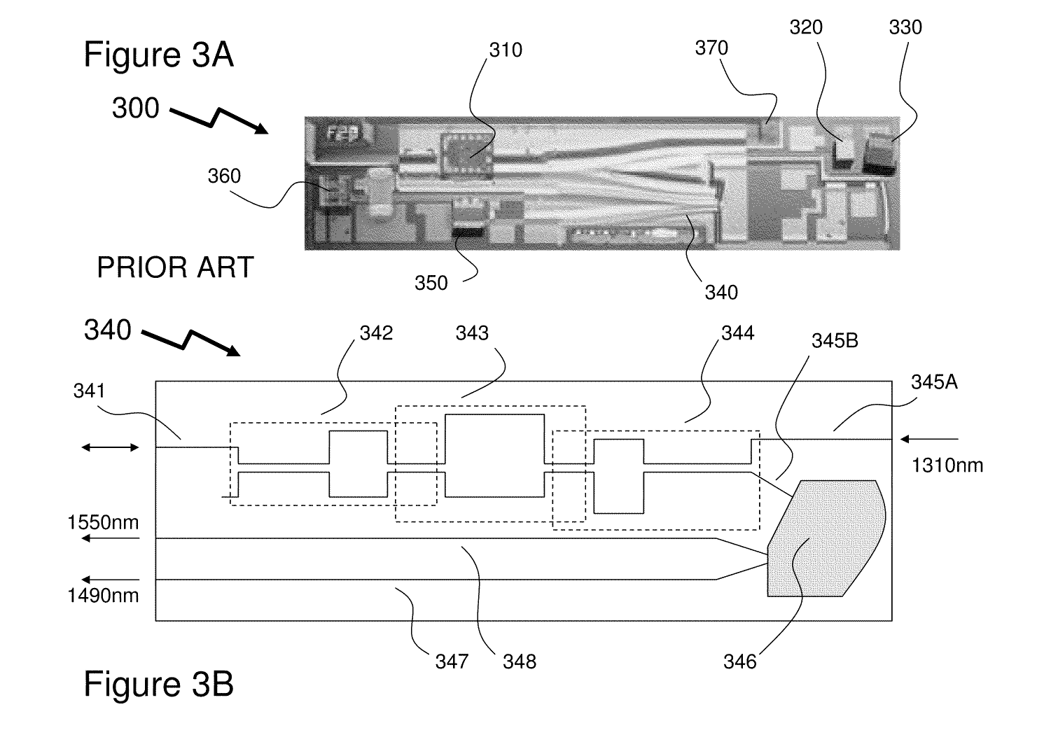

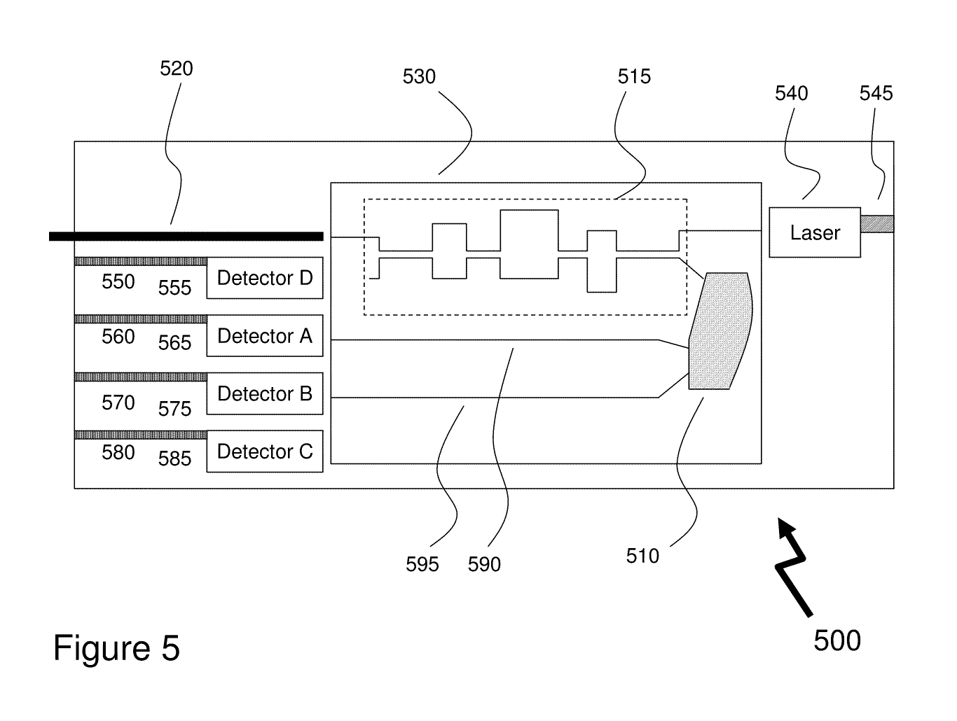

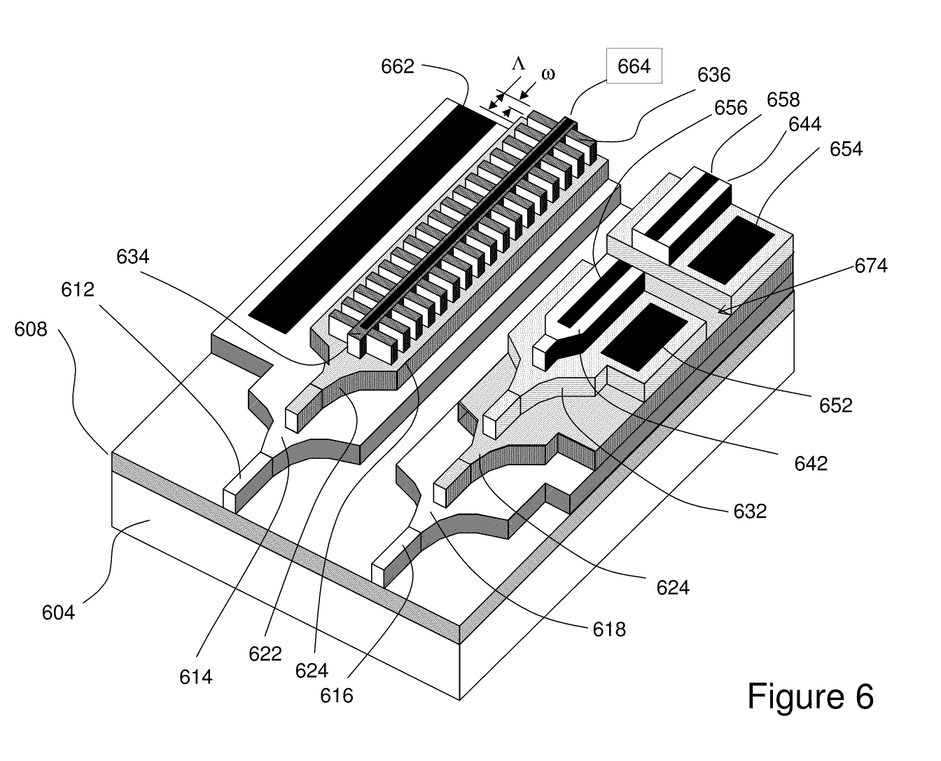

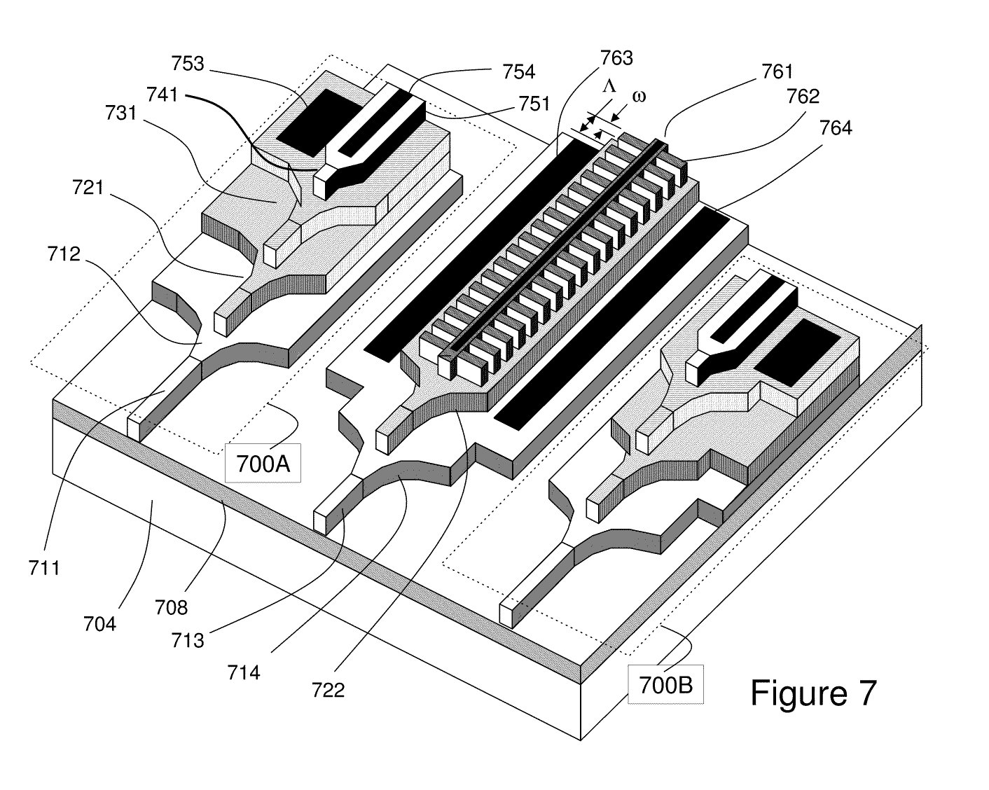

With respect to semiconductor embodiments of the invention references to optical waveguides are made typically by reference to etched ridge waveguide structures and may be identified solely by the ridge element in one, typically uppermost, layer of each etched ridge waveguide structure. Such referencing is intended to simplify the descriptions rather than implying the optical waveguide of any element solely comprises the upper etched ridge element identified. The scope of the present invention as one skilled in the art would appreciate is not intended to be limited therefore to such etched ridge waveguides as these represent only some of the possible embodiments. It would be further apparent to one of skill in the art that whilst the embodiments presented below are presented with respect to specific semiconductor implementations (FIGS. 6 and 7) and hybrid implementations (FIGS. 3A, 3B and 5) that the invention as taught may be applied to a variety of materials systems, construction principles, employing either discretely or in combination, integrated photonic circuits, hybrid optical assemblies or free-space optics. Further where specific materials, such as InP or silica-on-silicon are referred to these similarly represent just representative embodiments of the materials that may be employed, which may for example include but not be limited to GaAs, InGaN, InGaAsP, silicon, silicon oxynitride, polymer, ion-exchanged glass, quantum well structures, quantum dots, etc.

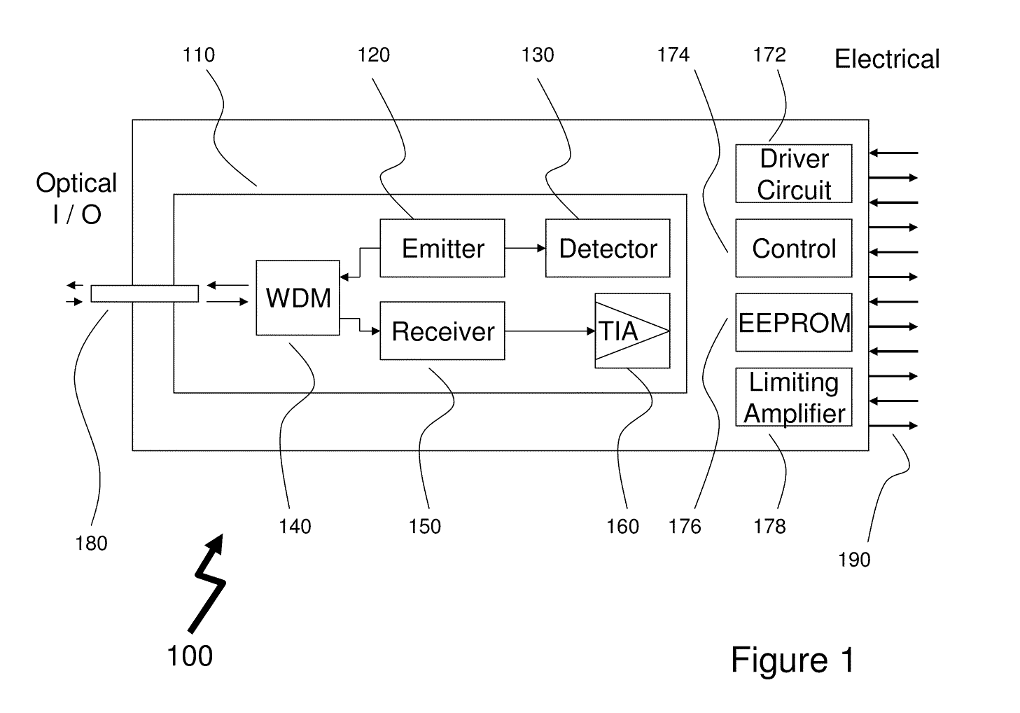

Referring to FIG. 1 there is illustrated an optical transceiver 100 according to the prior art. Accordingly an optical fiber 180 is shown providing the bidirectional optical interface to the optical network to which optical transceiver 100 is connected. From optical fiber 180 optical signals to/from the network are coupled to a wavelength multiplexer/demultiplexer (WDM) 140. Interfaces to the WDM 140 are an optical emitter 120 providing optical signals for transmission to the optical network and optical receiver 150 which receives optical signals intended for electrical equipment connected to the optical network via the optical transceiver 100 including for example VOIP telephones, computers, gaming consoles, and audiovisual entertainment systems. Coupled to the optical emitter 120 is a photodetector 130 that provides a power, and optionally performance, feedback signal to the ancillary electronics. Also coupled to the optical receiver 150 is a transimpedance amplifier (TIA) 160 which provides an electrical amplification of the electrical photocurrent generated within the optical receiver 150.

Within the optical transceiver 100 are provided electronic circuits including, but not necessarily limited to, driver circuit 172, control circuit 174, EEPROM 176 and limiting amplifier 178. These electronic circuits being interfaced directly or through other electrical circuits, not shown for clarity, to the electrical input/output interface 190. Accordingly a signal for communication to the optical network is received through the electrical input/output interface 190 and coupled through driver circuit 172 to optical emitter 120 and therein through the WDM 140 to the optical network via optical fiber 180. Similarly optical signals intended for the ancillary equipment connected to optical transceiver 100 are received by optical transceiver 100 and coupled via optical fiber 180 and WDM 140 to optical receiver 150. The electrical output from optical receiver 150 being coupled therein to the TIA 160 and limiting amplifier 178 before being coupled to the electrical input/output interface 190. Overall control of the optical transceiver 100 being undertaken by the control circuit 174 in conjunction with settings stored within the EEPROM 176 and in dependence upon a feedback signal from photodetector 130.

It would be apparent to one skilled in the art that such an optical transceiver 100 performs according to the optical signals transmitted by optical emitter 120 and received by the optical receiver 150. Crosstalk within the optical transceiver 100 may arise optically such as optically coupled signals from the optical emitter 120 or electrically such as coupling from the driver circuit 172 and/or electrical transmission lines (not shown for clarity) between driver circuit 172 and optical emitter. Such optical crosstalk in the received electrical signal from the optical receiver 150 is amplified by TIA 160 as is any electrical crosstalk coupled to the transmission line (not shown for clarity) interconnecting the optical receiver 150 and TIA 160. Additionally crosstalk contributions may arise in the electrical signal after the TIA 160 in the interfacing of the TIA to the limiting amplifier 178, however these are not addressed within the embodiments of the invention described below.

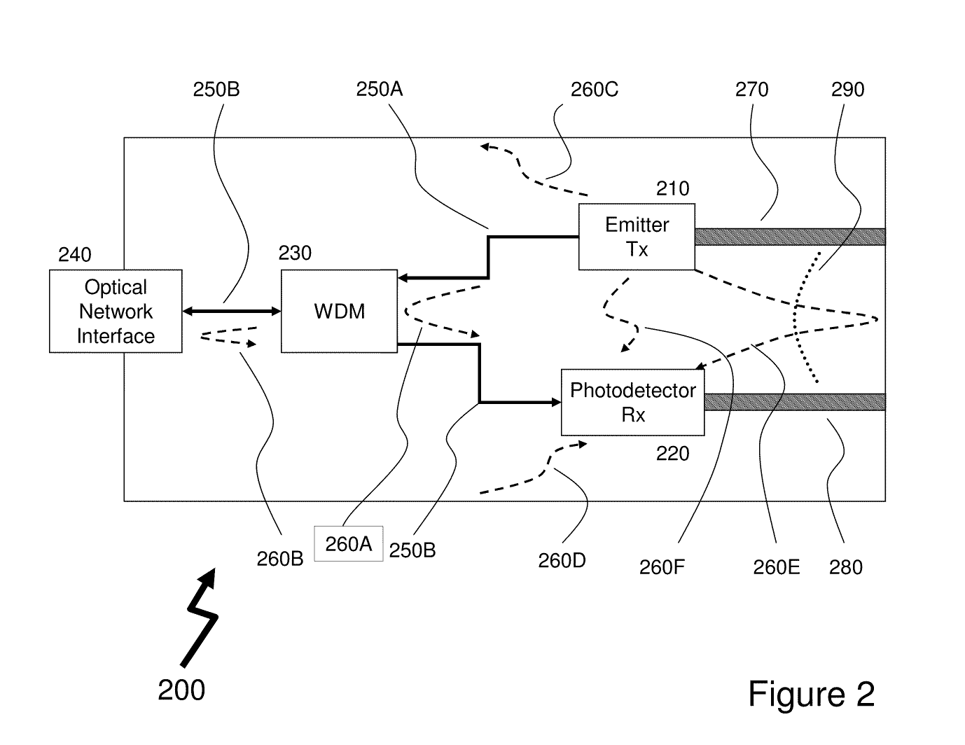

Now referring to FIG. 2 there is illustrated a bidirectional monolithic optical transceiver circuit 200 according to the prior art to illustrate the optical and electrical cross-coupling mechanisms between the optical emitter 210 and photodetector 220 within the bidirectional monolithic optical transceiver circuit 200. Bidirectional monolithic optical transceiver circuit 200 being for example an InP PIC. As shown an optical network interface 240 provides an interface to the optical network, not shown for clarity, from the bidirectional monolithic optical transceiver circuit 200. The optical network interface 240 receives optical signals from the optical network and couples them to the photodetector 220 via WDM 230. Similarly signals for transmittal to the optical network are generated within emitter 210 and coupled to the optical network interface 240 via WDM 230. The electrical drive signal to the emitter 210 is provided via a first electrical track 270. Electrical signals from the photodetector 220 are coupled to the external electrical circuitry via second electrical track 280.

Crosstalk between the emitter 210 and photodetector 220 may occur from multiple sources including but not limited to direct optical cross-coupling 260F between emitter 210 and photodetector 220, first indirect optical crosstalk 260E from emitter 210 and photodetector 220, second indirect optical crosstalk 260C and third indirect optical crosstalk 260D. Second indirect optical crosstalk 260C and third indirect optical crosstalk 260D relate to optical signals coupled from the emitter 210 to the photodetector 220 via reflections within the substrate. Indirect crosstalk may include WDM crosstalk 260A, optical network interface crosstalk 260B as well as other sources not explicitly identified including for example scattering from the optical waveguide interconnects between WDM 230 and emitter 210 and/or photodetector 220. These optical crosstalk signals act in combination with electrical crosstalk, represented by direct electrical crosstalk 290 between the first electrical track 270, providing transmit modulation data to the emitter 210 from external driver circuitry (not shown for clarity), and second electrical track 280, coupling the received modulated data from the photodetector 220 to external receiver circuitry (not shown for clarity but including for example a transimpedance amplifier and/or limiting amplifier). It would be evident to one skilled in the art that these optical and electrical crosstalk signals act generally to reduce the signal-to-noise ratio of the received signal.

Now referring to FIG. 3 there is shown a silica-on-silicon bidirectional optical hybrid transceiver 300 according to the prior art of S. Bidnyk et al “Silicon-on-insulator Based Planar Circuit for Passive Optical Network Applications” (IEEE Phot. Tech. Lett. Nov. 15, 2006, pp. 2392-pp. 2394). As shown silica-on-silicon bidirectional optical hybrid transceiver 300 comprises a silicon substrate 370 which has formed thereupon a silica-on-silicon planar waveguide circuit 340 which provides using passive waveguides the necessary routing and interconnection elements for the silica-on-silicon bidirectional optical hybrid transceiver 300. Such routing and interconnection being required to couple the optical signal emitted by 1310 nm laser diode 320 to the optical fiber interconnection, not shown for clarity, and the received optical signals to the 1490 nm photodetector 350 and 1550 nm photodetector 360. The electrical output from the 1490 nm photodetector 350 being coupled to a TIA 310 assembled onto the silicon substrate 370. Disposed at the rear facet of the 1310 nm laser diode 320 is a rear facet monitor 330. Each of the 1310 nm laser diode 320, rear facet monitor 330, 1490 nm photodetector 350, and 1550 nm photodetector 360 being mounted to the silicon substrate 370. Silica-on-silicon bidirectional optical hybrid transceiver 300 providing triplexer functionality with a single upstream channel and two downstream channels.

Referring to FIG. 3B the functionality of the silica-on-silicon planar waveguide circuit 340 is presented. As such there is an input waveguide 345A for receiving the optical signal from the 1310 nm laser diode 320 and coupling this to a first port of third Mach-Zehnder interferometer 344 and therein via first and second Mach-Zehnder interferometers 342 and 343 respectively to optical fiber waveguide 341 which in a packaged component would be coupled to an optical fiber. Optical signals received from the network would be coupled to optical fiber waveguide 341 and processed through first to third Mach-Zehnder interferometers 342 to 344 respectively. Optical signals intended for the 1490 nm photodetector 350 and 1550 nm photodetector 360 being coupled to the other port 345B of the third Mach-Zehnder interferometer 344 and therein to echelle grating 346 wherein they are demultiplexed to first and second output waveguides 347 and 348 respectively. First output waveguide 347 having signals within a predetermined wavelength range centered at 1490 nm and second output waveguide 348 having signals within a predetermined wavelength range centered at 1550 nm.

It would be evident to one skilled in the art that optical crosstalk may occur for example between the 1310 nm laser diode 320 and the 1490 nm photodetector 350 and 1550 nm photodetector 360 from losses incurred coupling the 1310 nm laser diode to the input waveguide 345A, losses within the first to third Mach-Zehnder interferometers 342 to 344 respectively and reflections existing at the optical fiber waveguide 341 interface to the optical fiber which due to wavelength specific properties of intermediate optical components become unguided signals within the substrate and/or other layers within the structure (not shown for clarity). Electrical crosstalk may be incurred between the electrical transmission line (not shown for clarity) on the silicon substrate 370 coupled to the 1310 nm laser diode 320 and the receiver transmission lines (not shown for clarity) from each of the 1490 nm photodetector 350 and 1550 nm photodetector 360, or to the transmission line from the TIA 310. As such it would evident to one skilled in the art that similar degradations may exist within silica-on-silicon bidirectional optical hybrid transceiver 300 as arise within a PIC such as bidirectional monolithic optical transceiver circuit 200 presented supra in FIG. 2.

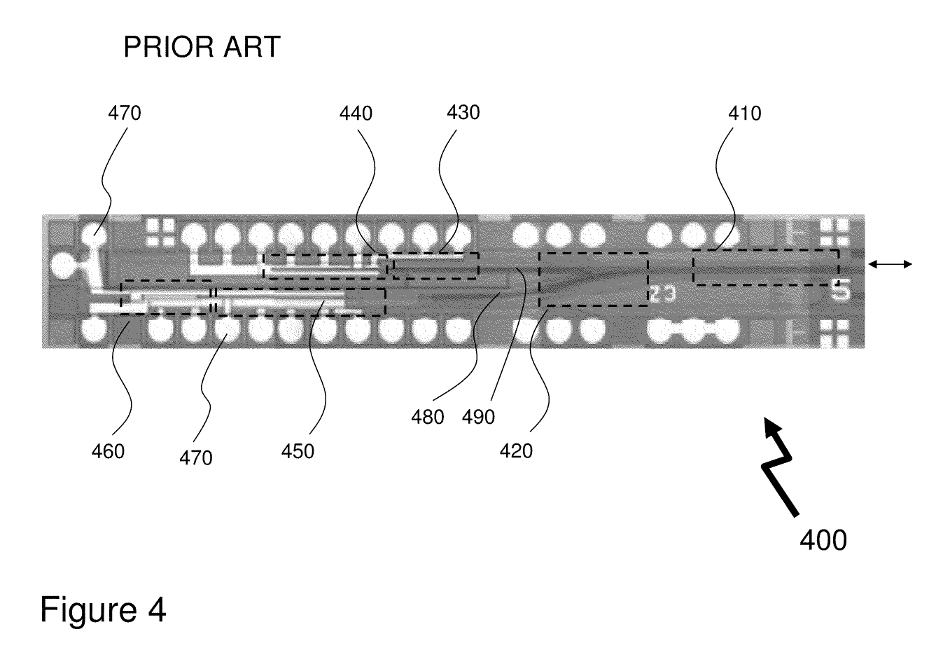

Referring to FIG. 4 there is illustrated a monolithic bidirectional optical transceiver 400 according to the prior art, see Tolstikhin et al “One-Step Growth Optical Transceiver PIC in InP” (Proc. ECOC 2009, 20-24 Sep. 2009, Vienna, Austria Paper 8.6.2), providing the functionality of the bidirectional monolithic optical transceiver circuit 200 presented supra in FIG. 2. Accordingly to the right of the monolithic bidirectional optical transceiver 400 is a spot-size converter waveguide (SSC) 410 which interfaces between the typically small asymmetric modes of an InP PIC and the circularly symmetric mode of the optical fiber which would be interfaced to the monolithic bidirectional optical transceiver 400. Disposed adjacent the SSC 410 is wavelength demultiplexer (WDM) 420 which acts to route signals from the SSC 410 to the receiver and transmitter portions of the monolithic bidirectional optical transceiver 400.

First interconnect 490 couples from the wavelength splitter 420 to a wavelength selective absorber (WSA) 430 which is itself coupled to a broadband PIN photodetector (BPD) 440, thereby forming the receiver section of the monolithic bidirectional optical transceiver 400. Second interconnect 480 is coupled from the WDM 420 to one end of a laterally coupled DFB laser (DFBL) 450. The other end of DFBL 450 being coupled to a back-side power monitor (BSPM) 460. The DFBL 450 and BSPM 460 forming the transmitter portion of the monolithic bidirectional optical transceiver 400. Electrical interfacing to each of the active circuit elements, namely BPD 440, DFBL 450, and BSPM 460 is provided by bond pads 470. With typical physical dimensions of a monolithic bidirectional optical transceiver 400 being a few millimeters by a millimeter or so compared with physical dimensions of a few tens of millimeters by ten or so millimeters for a silica-on-silicon bidirectional optical hybrid transceiver 300 it would be evident that coupling such as electrical crosstalk between the electrical transmission line(s) to the DFBL 450 and the electrical transmission line(s) from the BPD 440 upon the monolithic bidirectional optical transceiver 400, which has a dependency that reduces as the square of the separation of the transmission lines, and optical crosstalk from signals radiated into the substrate, that may be thought in a simple view to reduce linearly with element separation, become more severe as dimensions of the optical assembly reduces.

Referring to FIG. 5 there is illustrated an embodiment of the invention for a bidirectional optical triplexer 500 exploiting a silica-on-silicon optical hybrid 530. Coupled to the silica-on-silicon optical hybrid 530 is an optical fiber 520 providing the bidirectional interface for the bidirectional optical triplexer 500 to the optical network, not shown for clarity. Also coupled to the silica-on-silicon optical hybrid 530 is 1310 nm laser 540 which provides the upstream optical signals for the bidirectional optical triplexer 500, which is connected to external driver circuitry, not shown for clarity, via first transmission line 545. The 1310 nm laser diode 540 and optical fiber 520 being connected via multi-stage Mach-Zehnder interferometer (MSMZI) 515 within the silica-on-silicon optical hybrid 530. The MSMZI 515 is also coupled to an echelle grating 510 which acts to separate 1490 nm and 1550 nm downstream signals to first interconnect 590 and second interconnect 595 respectively. The MSMZI 515 acting to wavelength multiplexer/demultiplex the 1490 nm/1550 nm downstream channels from the 1310 nm upstream channel.

First interconnect 590 couples at a facet of silica-on-silicon optical hybrid 530 to Detector A 565 which thereby acts as the 1490 nm downstream optical receiver, and second interconnect 595 couples at the same facet of silica-on-silicon optical hybrid 530 to Detector B 575 which thereby acts as the 1550 nm downstream optical receiver. The converted electrical signals from each of Detector A 565 and Detector B are coupled to external receiver circuitry, not shown for clarity, via third and fourth transmission lines 560 and 570 respectively. Disposed adjacent to Detector A 565 is Detector D 555, and disposed adjacent to Detector B 575 is Detector C 585. Electrical signals from each of Detector D 555 and Detector C 585 being coupled via second and fifth transmission lines 550 and 580 respectively. As such Detector D 550 receives optical crosstalk in a location physically close to Detector A 560 and Detector C 580 receives optical crosstalk in a location physically close to Detector B 570. Additionally second and fifth transmission lines 550 and 580 respectively are physically close to third and fourth transmission lines 560 and 570 associated with Detector A 565 and Detector B 575 respectively such that electrical crosstalk occurring within these transmissions lines also occurs within second and fifth transmission lines 550 and 580.

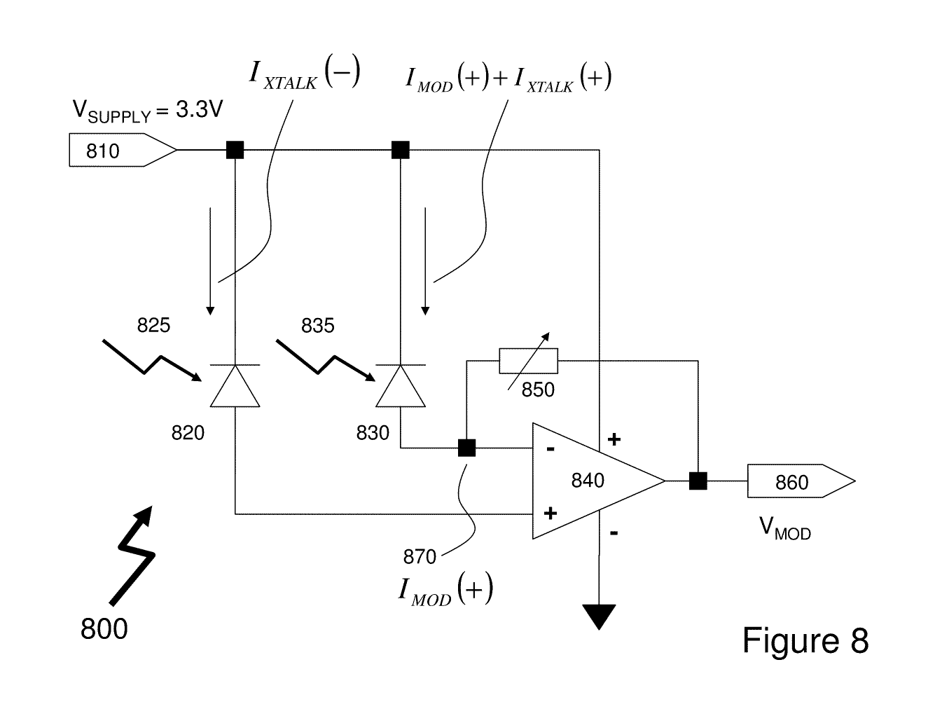

As will be evident from FIGS. 8 through 10 below the electrical signals received a particular receiver photodetector and its associated partner photodetector, for example Detector A 565 and Detector D 555 or Detector B 575 and Detector C 585, can be electrically combined to remove the signals associated with either optical crosstalk to the photodetector or electrical crosstalk from the transmission line(s) to the 1310 nm laser 540 and the electrical transmission line(s) from the photodetectors before the TIA. Accordingly bidirectional optical triplexer 500 is implemented by employing two photodetectors for each receiver channel.

It would be apparent to one skilled in the art that whilst the embodiment presented supra employs a silica-on-silicon optical circuit to implement the passive interconnection and routing that this optical circuit may be implemented in a range of other material systems, including but not limited to, ion-exchanged glass, polymers, and silicon oxynitride on silicon, without departing from the scope of the invention. Equally the photodetectors may be implemented as integrated pairs or arrays of photodetectors.

Referring to FIG. 6 there is illustrated an embodiment of the invention for an InP PIC wherein a second compensating photodetector is implemented within the same multi-guide vertical integration (MGVI) structure behind the primary receiver photodetector. Accordingly there is shown an MGVI structure, see for example V. Tolstikhin et al. in “Optically Pre-Amplified Detectors for Multi-Guide Vertical Integration in InP” (Proc. Indium Phosphide and Related Materials 2009, pp. 155-158, Newport Beach, 2009), comprising an InP substrate 604 upon which have been grown semiconductor layers in a single epitaxial growth process and subsequently processed and patterned to form passive and active waveguides as determined by the composition of the layers. The bottom passive layer 608 within the MGVI structure being a waveguide layer within which the wavelength demultiplexer, such as WDM 420 of FIG. 4 supra, of a bidirectional optical transceiver would be implemented together with passive waveguides for routing and interconnection. These elements being omitted for clarity.

As shown formed above passive layer 608 are a series of waveguide taper structures which act in concert with each other to couple an optical signal between the uppermost layer of the MGVI structure at that location in the InP PIC and the passive layer 608. Hence, on the left side of FIG. 6 there is formed first waveguide 612 within a first layer, not identified for clarity, being above the passive layer 608 which acts to form a rib loaded waveguide with passive layer 608 to guide optical signals in the passive layer 608. Formed behind first waveguide 612 is first taper 614 upon which is disposed a second taper 622 formed within a second layer of the MGVI structure. As such an optical signal within the wavelength range of the second layer is adiabatically coupled to the passive layer 608 and vice-versa. Also formed within the second layer as second taper 622 is second waveguide 624. Formed atop second waveguide 624 in a third layer of the MGVI structure is rib element 634 which provides for a rib loaded waveguide within the third layer.

Disposed adjacent to rib element 634 are a periodic array of lateral features 636 of width ω and pitch Λ to form a distributed Bragg grating within the second layer which forms the intrinsic layer within a p-i-n structure. Deposited atop rib element 634 is first electrode 664 and deposited adjacent to second waveguide 624 is a second electrode 662. Application of a forward bias between first electrode 664 and second electrode 662 resulting in optical emission which in conjunction with the distributed Bragg grating acts to provide a distributed feedback laser (DFB) structure. Accordingly emission from this DFB is coupled from the second waveguide 624 down to the passive layer 608 by the action of second taper 622 and first taper 612 wherein it would be guided to the wavelength multiplexer, not shown for clarity.

On the right hand side of FIG. 6 there is shown a third waveguide 616 formed within the first layer within the MGVI and acts to form a rib loaded waveguide with passive layer 608 to guide optical signals in the passive layer 608. Formed behind third waveguide 616 is third taper 618 within the first layer, atop of which are formed fourth taper 626 and fifth taper 632 within the second and third layers of the MGVI structure respectfully. Third, fourth and fifth tapers 618, 626 and 632 respectfully act to couple optical signals to/from the passive layer 608 to the third layer of the MGVI structure. Formed atop fifth taper 632 is fourth waveguide 642 which has third electrode 656 formed onto its upper surface and fourth electrode 652 formed beside on the upper surface of third layer, these electrodes acting in conjunction with the p-i-n structure formed with the third layer as the intrinsic region to apply a reverse bias to this active layer making the region formed by fourth waveguide 642 act as a first photodetector.

Formed behind this structure atop second layer is first element 636 formed within the third layer, which is separated from fifth taper 632 by etching through the third layer. Formed atop the first element 636 is fifth waveguide 644 having on its upper surface fifth electrode 658. Adjacent fifth waveguide 644 is sixth electrode 654 formed on the upper surface of the second layer. These electrodes acting in conjunction with the p-i-n structure formed with the third layer as the intrinsic region to apply a reverse bias to this active layer making the region formed by fifth waveguide 644 act as a second photodetector. As optical signals within the passive layer 608 within the wavelength range of the first photodetector were coupled up into third layer by the combined action of the third, fourth and fifth tapers 618, 626 and 632 respectfully and absorbed within the first photodetector, those optical signals present within the second photodetector are crosstalk. To further rejected the optical signals intended for the first photodetector a trench 674 is deposed between the first photodetector and the second photodetector. Not shown for clarity are transmission lines coupled to the first electrode 664, third electrode 656 and fifth electrode 658. Electrical crosstalk from the transmission lines for the DFB laser which comprises electrodes 662 and 664 couple to the transmission line of the first photodetector which comprise electrodes 656 and 652; and between the transmission line for the DFB laser and the transmission line of the second photodetector, which comprise electrodes 654 and 658. As shown subsequently in FIGS. 8 through 10 this electrical crosstalk to the transmission line of the second photodetector can be employed to compensate for the electrical crosstalk to the transmission line of the first photodetector.

Referring to FIG. 7 there is illustrated an embodiment of the invention wherein the second compensating photodetector is implemented adjacent the optical emitter in corresponding relation to the optical emitter as the primary receiver photodetector. The optical transceiver comprising optical transmitter, optical receiver, WDM and ancillary passive circuit elements is shown absent said passive circuit elements and WDM for clarity, the optical transceiver being formed upon a substrate 704 using a MGVI structure which comprises a plurality of passive and active waveguide layers beginning with passive layer 708. As shown in FIG. 7 in the middle is the optical transmitter which comprises at its lowest level first waveguide 713 which acts to form a rib loaded waveguide with the passive layer 708. Coupled to first waveguide 713 within the second layer of the MGVI structure is first taper 714. Formed atop of first waveguide 713 is second taper 722 with the third layer of the MGVI structure. Accordingly first taper 714 and second taper 722 act to couple optical signals to/from the passive layer 708 from/to the second layer of the MGVI structure.

Formed atop second taper 722 is rib element 761 which acts to form a rib waveguide within the second layer. Disposed adjacent to rib element 761 are a periodic array of lateral features 762 of width a and pitch A which form a distributed Bragg grating within the second layer which forms the intrinsic layer within a p-i-n structure. Electrical biasing of the p-i-n structure is achieved through a first electrode, not numbered for clarity, and second and third electrodes 763 and 764 formed adjacent the second taper 634, these being formed on the upper surface of the first layer. Accordingly forward biasing via the first electrode results in optical emission which in conjunction with the distributed Bragg grating results in the structure acting as a DFB laser. The emitted light from this structure is then optically coupled from the DFB laser to the passive layer 708 by the combined action of second taper 722 and first taper 714 wherein it is guided by first waveguide 713 into the remainder of the PIC of which the DFB laser is part.

Now considering first and second detector structures 700A and 700B respectively which are disposed to the left and right respectively of the laser structure described supra. Each of the first and second detector structures 700A and 700B respectively comprises a second waveguide 711 formed atop the passive layer 708 forming a rib loaded waveguide structure guiding optical signals coupled to this structure. Second waveguide 711 is coupled therein to third taper 712 formed within the first layer which then has formed above it fourth taper 721 within the third layer. Atop this is then fifth taper 731 formed within the fourth layer. The combined effect of third taper 721, fourth taper 731, and fifth taper 741 is to couple any optical signals propagating within the rib loaded waveguide formed from second waveguide 711 and passive layer 708 into the third layer of the MGVI structure. Confinement within the third layer element formed by fifth taper 731 being provided by the third waveguide 741 and fourth waveguide 751 which are formed within the fourth layer, not identified for clarity.

Formed atop the fourth waveguide 751 is fourth electrode 754, and formed adjacent to the fourth waveguide 751 is fifth electrode 753 which is deposited onto the upper surface of the third layer. These electrodes allowing the p-i-n structure comprising at least the third layer and fourth layer to be biased wherein the resulting effect is an optical photodetector. As such any optical signals propagating within each second waveguide 711 are coupled vertically through the MVGI structure to the photodetector and electrically coupled out via a transmission line coupled to either fourth electrode 754 or fifth electrode 753. Of the first photodetector 700A and second photodetector 700B only one is optically coupled to the intended receiver channel, for example via a wavelength demultiplexer, and hence receives the intended receiver signal. However, both photodetectors receive the optical and electrical crosstalk.

It would be apparent to one skilled in the art that the first and second photodetector structures 700A and 700B are disposed symmetrically to the laser structure disposed between them. Accordingly sources of optical crosstalk such as spontaneous emission from the laser structure, light coupled to the substrate from the vertical coupling to the passive layer 708 may be reasonably expected to be comparable within the two photodetectors. Placement of the combined three element structure symmetrically with respect to the optical die centre line may also improve the degree to which the two photodetectors receive optical crosstalk arising from optical signals coupled into the substrate etc. Other arrangements of the first and second photodetector may be employed without departing from the scope or spirit of the invention as would be evident to one skilled in the art.

It would be apparent to one skilled in the art that alternate semiconductor integration methodologies may be employed to form both the laser structure and photodetectors within either FIG. 7 or FIG. 8 and thereby replace the MGVI approach presented for the integration of these active and passive waveguides. The monolithic integration of multiple waveguide devices, such as the laser diode and photodetector, having different waveguide core regions made from different semiconductor materials due to their operation at different wavelengths can be achieved by essentially one of the three following ways:
1. direct butt-coupling; which exploits the ability to perform multiple steps of epitaxial growth, including selective area etching and re-growth, to provide the multiple semiconductor materials, which are spatially differentiated horizontally with a common vertical plane across the PIC die and the different semiconductor materials are grown adjacent horizontally so that waveguides formed in each directly butt against one another to form the transition from one material to another;
2. modified butt-coupling; which exploits selective area post-growth modification of semiconductor material, e.g. by means of quantum-well intermixing techniques, rather than etching and re-growth, to form the regions of required semiconductor material, also spatially differentiated in the common plane of vertical guiding across the PIC die; and
3. evanescent-field coupling; where vertically separated and yet optically coupled waveguides featuring different semiconductor materials for their core regions, are employed to provide the required material variance without additional growth steps, such that it is now differentiated in the common vertical stack of the PIC die.

Examples of integrating multiple devices using direct butt-coupling has been reported for example by Haleman et al in U.S. Pat. No. 5,029,297, “Optical-Amplifier-Photodetector Device”, W. Rideout et al in U.S. Pat. No. 5,299,057 “Monolithically Integrated Optical Amplifier and Photodetector Tap”, and J. Walker et al in U.S. Pat. No. 6,909,536 “Optical Receiver including a Linear Semiconductor Optical Amplifier”. An example of modified butt-coupling is presented by M. Aoki et al in U.S. Pat. No. 5,574,289 “Semiconductor Optical Integrated Device and Light Receiver Using Said Device”. Finally, an integrated approach based on evanescent-field coupling in a vertical twin-waveguide structure has been reported by S. Forrest et al. in U.S. Pat. No. 7,343,061 entitled “Integrated Photonic Amplifier and Detector”.

Expansion to monolithic PICs has been in contrast less reported, but examples include V. Tolstikhin et al “One-Step Growth Optical Transceiver PICs in InP” (Proc. ECOC 2009, Sep. 20-24 2009, Paper 8.6.2), F. Kish et al in U.S. Pat. No. 7,466,882 entitled “Monolithic Transmitter/Receiver Photonic Integrated Circuit (Tx/RxPIC) Transceiver Chip”, D. F. Welch et al in U.S. Pat. No. 7,340,122 entitled “Monolithic Transmitter Photonic Integrated Circuit (TxPIC) with Integrated Optical Components in Circuit Signal Channels”, and C. Joyner in U.S. Pat. No. 7,457,496 “Receiver Photonic Integrated Circuit (RxPIC) Chip utilizing Compact Wavelength Selective Decombiners.” It would be apparent to one skilled in the art that the invention may be applied to any integration approach without departing from its scope as defined by the claims.

As discussed supra the invention relates to combining the signal from a secondary photodetector receiving essentially only crosstalk with a primary photodetector receiving an intended signal together with this crosstalk. Accordingly in FIG. 8 there is illustrated a first circuit 800 according to an embodiment of the invention for connecting the primary and secondary photodetectors 830 and 820 respectively using a differential transimpedance amplifier 840 to improve an aspect of performance of the primary receiver. Accordingly as shown primary photodetector 830 receives optical signals 835 and generates a photocurrent equivalent to I_{MOD}(+)+I_{XTALK}(+), wherein I_{MOD}(+) corresponds to the optically induced photocurrent from the desired modulated signal and I_{XTALK}(+) corresponds to optically induced photocurrent arising from the crosstalk within primary photodetector 830 induced from optical crosstalk within the optical transceiver of which primary photodetector 830 forms part. Primary photodetector 830 being coupled from power supply 810 to the inverting input of a differential transimpedance amplifier 840. Similarly secondary photodetector 820 receives optical signals 825 and generates a photocurrent equivalent to I_{XTALK}(−), wherein I_{XTALK}(−) corresponds to optically induced photocurrent arising from the crosstalk within secondary photodetector 820 induced from optical crosstalk within the optical transceiver of which secondary photodetector 820 forms part. Secondary photodetector 830 being coupled from power supply 810 to the non-inverting input of the differential transimpedance amplifier 840. Within this embodiment power supply 810 is set to be 3.3V.

Also coupled from the first input of the differential transimpedance amplifier 840 to its output is feed-forward resistor 850, which is variable, such that at the output 860 coupled to the differential transimpedance amplifier 840 an output voltage V_{MOD} is generated which is an amplified representation of the received modulated signal as the received crosstalk contributions I_{XTALK}(+) and I_{XTALK}(−) from the primary and secondary photodetectors 830 and 820 respectively cancel out.

It would be apparent to one skilled in the art that whilst the primary and secondary photodetectors 830 and 820 respectively are presented within FIG. 8 as generating equivalent crosstalk induced photocurrents that imbalances within the performance of either photodetector together with variations in the distribution of optical crosstalk within the optical transceiver, which may also vary according to the mechanism of their generation, may result in the crosstalk induced photocurrent from the primary and secondary photodetectors 830 and 820 respectively being imbalanced. Accordingly it may be appropriate to introduce a variable resistance, not shown for clarity, between for example the power supply 810 and the secondary photodetector 820 thereby allowing the effective photocurrent to be scaled. Optionally another variable resistance may be applied between the power supply and the primary photodetector 830.

Further whilst the description supra has been discussed in relation to the optical crosstalk it would be apparent to one skilled in the art that electrical crosstalk incurred on the electrical interconnection of the primary photodetector 820 to the differential transimpedance amplifier 840 would also be incurred on the electrical interconnection of the secondary photodetector 830 to the differential transimpedance amplifier 840 and thereby similarly compensated for by the electrical summation occurring within the differential transimpedance amplifier 840. It would be apparent to one of skill in the art that alternate differential configurations are possible working within the current domain as well as configurations wherein the currents are converted to voltage prior to difference determination.

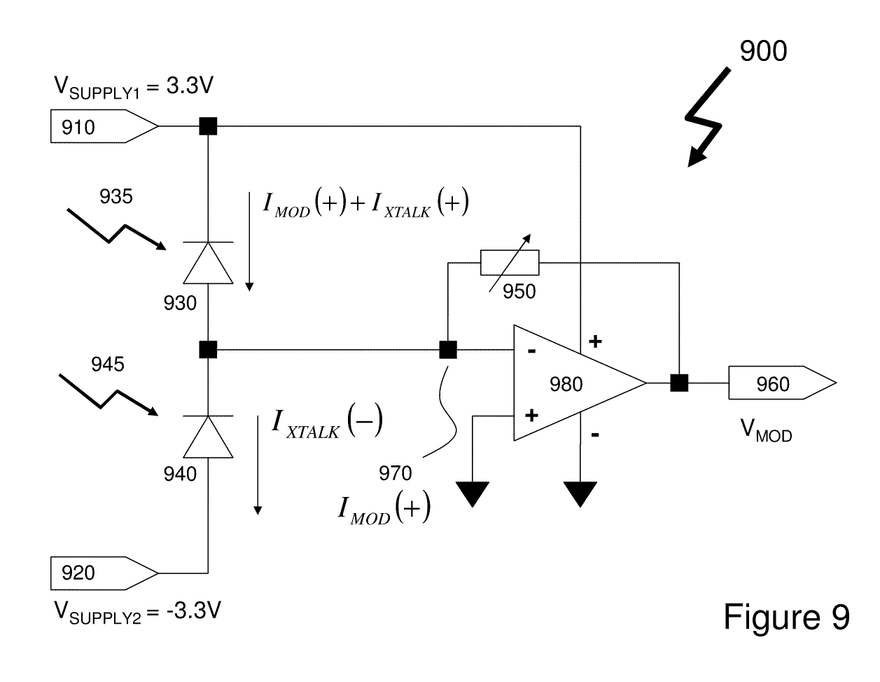

Referring to FIG. 9 there is illustrated a second circuit 900 according to an embodiment of the invention for connecting a primary photodetector 930 and secondary photodetector 940 to improve an aspect of performance of an optical receiver by employing dual power supply rails and a transimpedance amplifier 980. Accordingly the primary photodetector 930 and secondary photodetector 940 are connected in series between a first power supply rail 910, V_{SUPPLY1}=3.3V , and a second power supply rail 920, V_{SUPPLY2}=−3.3V . The mid-point between the first photodetector 930 and second photodetector 940 being coupled to the inverting input port of the transimpedance amplifier 980. The non-inverting input of the transimpedance amplifier 980 being coupled to ground. First optical signal 935 thereby generates an induced photocurrent I_{PRIMARY}=I_{MOD}(+)+I_{XTALK}(+) whilst second optical signal 945 generates an induced photocurrent I_{SECONDARY}=I_{XTALK}(−) resulting in a photocurrent of I_{MOD}(+) at node 970. Node 970 is also coupled to the output of the transimpedance amplifier 980 via variable resistance 950 such that the output of the transimpedance amplifier 980 at output port 960 is V_{MOD}.

It would be evident that as with first circuit 800 that the induced crosstalk photocurrents arising from the first photodetector 930 and second photodetector 940 may be slightly imbalanced as a result of issues including but not limited to geometry, positioning, performance, etc. Accordingly second circuit 900 may include additionally additional variable resistance or resistances in series thereby allowing the crosstalk photocurrents to be balanced. Further, it would be apparent as discussed supra in respect of FIG. 8 that electrical crosstalk introduced into the received electrical signal by crosstalk from say an associated optical emitter to the electrical circuitry of the first photodetector 930 would also be introduced in the electrical circuitry from the second photodetector 940, and hence similarly compensated for in the operation of second circuit 900.

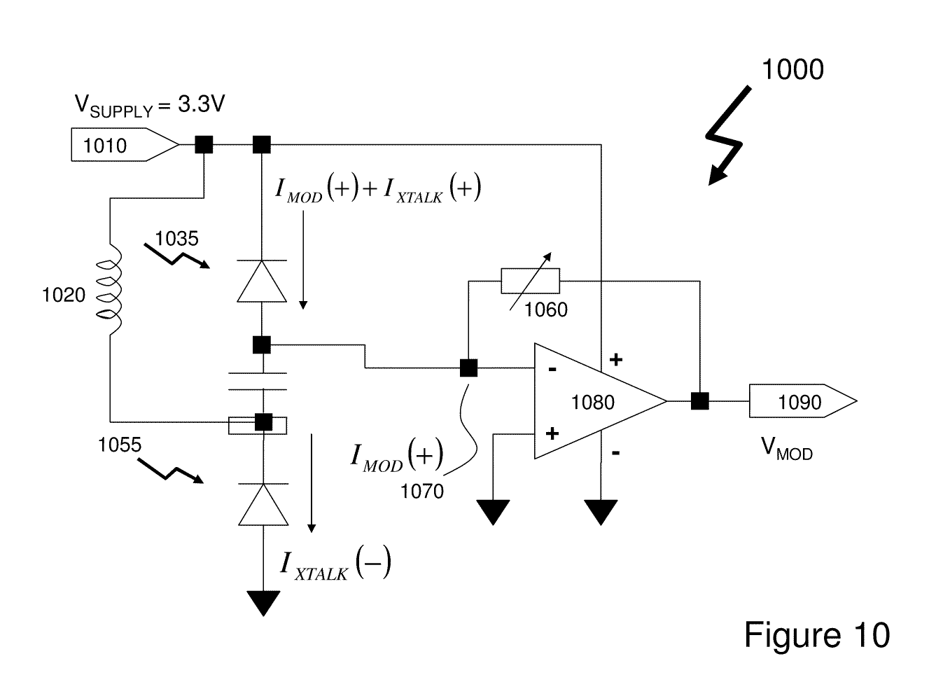

Referring to FIG. 10 there is illustrated a third circuit 1000 according to an embodiment of the invention for connecting a primary photodetector 1030 and secondary photodetector 1050 to improve an aspect of performance of the optical receiver incorporating primary photodetector 1030 using a single power supply 1010, a bias-Tee and a transimpedance amplifier 1080. Accordingly primary photodetector 1030 is connected between the power supply 1010, for example in this embodiment V_{SUPPLY}=3.3V, and the inverting input of transimpedance amplifier 1080. A capacitor 1040 is also connected in series between the cathode of the secondary photodetector 1050 and the anode of the first photodetector 1030. The anode of the secondary photodetector 1050 being connected to ground. The cathode of secondary photodetector 1050 is also connected to power supply 1010 by inductor 1020. Inductor 1020 in combination with capacitor 1040 providing the bias-Tee described supra.

Hence, first optical signal 1035 generates an induced photocurrent I_{PRIMARY}=I_{MOD}(+)+I_{XTALK}(+) within first photodetector 1030 whereas second optical signal 1055 generates an induced optical signal I_{SECONDARY}=I_{XTALK}(−) within the second photodetector 1050. Accordingly at node 1070 between the capacitor 1040 and anode of first photodetector 1030 the resulting current applied to the inverting input of the transimpedance amplifier 1080 is I_{MOD}(+). The non-inverting input of the transimpedance amplifier 1080 being coupled to ground. Node 1070 is also connected to the output of the transimpedance amplifier 1080 via variable resistance 1060. Accordingly the output of the transimpedance amplifier 1080 at output port 1090 is V_{MOD}.

The observations made supra in respect of FIGS. 8 and 9 also apply to the third circuit 1000 in that the third circuit 1000 also provides for cancellation of electrical crosstalk introduced into the intended receiver channel from an optical emitter. It would be apparent to one skilled in the art that the embodiments described supra in respect of FIGS. 8, 9 and 10 are presented on the basis of equivalent photocurrents and electrical currents arising from the different crosstalk mechanisms and that the difference of these is taken to correct for these crosstalk mechanisms. It would be further evident that manufacturing variations as well as actual crosstalk within the two photodetectors may be different. Correction for this imbalance may in some embodiments be reduced by adjusting the dimensions or location of the secondary photodetector, but it may also be adjusted in the electrical domain by the provisioning of a variable element within one or both connections to the differential amplifier, or whatever circuitry generates the difference between these signals.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A device comprising:
an optical input port in communication with an optical network for receiving and transmitting optical signals;
a wavelength multiplexer comprising a common port optically coupled to the optical input port and characterized by at least a first predetermined wavelength range, and two channel ports of a plurality of channel ports, each channel port characterized by at least a second predetermined wavelength range, each second predetermined wavelength range being within the first predetermined wavelength range;
an optical emitter coupled to the first channel port for transmitting an optical signal to the optical input port via the wavelength multiplexer, the optical emitter operating within the second predetermined wavelength range of the first channel port;
a first photodetector coupled to the second channel port of the wavelength multiplexer for receiving optical signals from the optical input port via the wavelength multiplexer and providing a first electrical signal; and
a second photodetector disposed in predetermined location relative to the first photodetector for providing a second electrical signal to be used in combination with the first electrical signal to improve a measure of the first electrical signal.

2. A device according to claim 1 wherein;
the device comprises at least one of a monolithic integrated circuit and a hybrid optical circuit.

3. A device according to claim 2 wherein;
the monolithic integrated circuit comprises an epitaxial semiconductor structure grown in a single growth step upon a substrate comprising a common designated waveguide for supporting propagation of optical signals within the predetermined first wavelength range and at least one of a plurality of wavelength designated waveguides vertically disposed in order of increasing wavelength bandgap, each of the plurality of wavelength designated waveguides supporting a predetermined second wavelength range, each of the predetermined second wavelength ranges being within the predetermined first wavelength range.

4. A device according to claim 1 wherein;
the first photodetector is disposed to one side of the optical emitter with a first predetermined relationship with respect to a longitudinal centre line of the optical emitter;
the second photodetector is disposed to the other side of the optical emitter with a second predetermined relationship with respect to a longitudinal centre line of the optical emitter.

5. A device according to claim 1 wherein;
the first photodetector and second photodetector are at least one of each connected to different inputs of a differential amplifier, connected serially between a first supply voltage and a second supply voltage, and connected serially via bias-tee such that the two photodetectors are each connected between a common supply voltage and ground.

6. A device according to claim 1 wherein;
at least a first electrical contact to at least one of the first photodetector and the second photodetector is connected to one end of a variable element.

7. A device according to claim 1 further comprising:
a correction circuit electrically connected to the first photodetector and second photodetector, the correction circuit for applying a correction signal to a first signal generated in dependence upon at least a first photocurrent generated within the first photodetector, the correction signal being generated in dependence upon at least a second photocurrent generated within the second photodetector.

8. A device according to claim 7 wherein;
the correction signal applies a correction for crosstalk within the device, the crosstalk being at least one of optical crosstalk from the optical emitter, optical crosstalk from optical signals received at the optical input port, and electrical crosstalk between a first electrical circuit connected to the optical emitter and a second electrical circuit connected to the first photodetector.

9. A device comprising:
an optical input port in communication with an optical network;
a wavelength multiplexer comprising a common port optically coupled to the optical input port and characterized by at least a first predetermined wavelength range, and at least one channel port of a plurality of channel ports, the channel port characterized by at least a second predetermined wavelength range, the second predetermined wavelength range being within the first predetermined wavelength range;
a first photodetector coupled to the one channel port of the wavelength multiplexer for receiving optical signals from the optical input port via the wavelength multiplexer and providing a first electrical signal; and
a second photodetector disposed in predetermined location relative to the first photodetector for providing a second electrical signal to be used in combination with the first electrical signal to improve a measure of the first electrical signal.

10. A device according to claim 9 further comprising:
a second channel port of the plurality of channel ports of the wavelength multiplexer,
an optical emitter coupled to the second channel port for transmitting an optical signal to the optical input port via the wavelength multiplexer, the optical emitter operating within the second predetermined wavelength range of the second channel port.

11. A device according to claim 9 wherein;
the device comprises at least one of a monolithic integrated circuit and a hybrid optical circuit.

12. A device according to claim 11 wherein;
the monolithic integrated circuit comprises an epitaxial semiconductor structure grown in a single growth step upon a substrate comprising a common designated waveguide for supporting propagation of optical signals within the predetermined first wavelength range and at least one of a plurality of wavelength designated waveguides vertically disposed in order of increasing wavelength bandgap, each of the plurality of wavelength designated waveguides supporting a predetermined wavelength range, each of the predetermined wavelength ranges being within the predetermined first wavelength range.

13. A device according to claim 9 wherein;
the first photodetector and second photodetector are at least one of each connected to different inputs of a differential amplifier, connected serially between a first supply voltage and a second supply voltage, and connected serially via bias-tee such that the two photodetectors are each connected between a common supply voltage and ground.

14. A device according to claim 9 wherein;
at least a first electrical contact to at least one of the first photodetector and the second photodetector is connected to one end of a variable resistance element.

15. A device according to claim 9 further comprising:
a correction circuit electrically connected to the first photodetector and second photodetector, the correction circuit for applying a correction signal to a first signal generated in dependence upon at least a first photocurrent generated within the first photodetector, the correction signal being generated in dependence upon at least a second photocurrent generated within the second photodetector.

16. A device according to claim 15 wherein;
the correction signal applies a correction for crosstalk within the device, the crosstalk being at least one of optical crosstalk from an optical emitter associated with the device, optical crosstalk from optical signals received at the optical input port, and electrical crosstalk between a first electrical circuit connected to an optical emitter associated with the device and a second electrical circuit connected to the first photodetector.

17. A method comprising:
providing an optical input port in communication with an optical network and for receiving and transmitting optical signals;
providing a wavelength multiplexer comprising a common port optically coupled to the optical input port and characterized by at least a first predetermined wavelength range, and at least one channel port of a plurality of channel ports, each channel port characterized by at least a second predetermined wavelength range, each second predetermined wavelength range being within the first predetermined wavelength range;
providing a first photodetector coupled to the one channel port of the wavelength multiplexer for receiving optical signals from the optical input port via the wavelength multiplexer and providing a first electrical signal; and
providing a second photodetector disposed in predetermined location relative to the first photodetector for providing a second electrical signal to be used in combination with the first electrical signal to improve a measure of the first electrical signal.

18. A method according to claim 17 further comprising:
providing a second channel port of the plurality of channel ports of the wavelength multiplexer,
providing an optical emitter coupled to the second channel port for transmitting an optical signal to the optical input port via the wavelength multiplexer, the optical emitter operating within the second predetermined wavelength range of the second channel port.

19. A method according to claim 17 wherein;
providing the wavelength multiplexer, first photodetector and second photodetector comprises providing at least one of a monolithic integrated circuit and a hybrid optical circuit.

20. A method according to claim 19 wherein;
providing a monolithic integrated circuit comprises providing at least an epitaxial semiconductor structure grown in a single growth step upon a substrate comprising a common designated waveguide for supporting propagation of optical signals within the predetermined first wavelength range and at least one of a plurality of wavelength designated waveguides vertically disposed in order of increasing wavelength bandgap, each of the plurality of wavelength designated waveguides supporting a predetermined second wavelength range, each of the predetermined second wavelength ranges being within the predetermined first wavelength range.

21. A method according to claim 17 wherein;
the first photodetector and second photodetector are at least one of each connected to different inputs of a differential amplifier, connected serially between a first supply voltage and a second supply voltage, and connected serially via bias-tee such that the two photodetectors are each connected between a common supply voltage and ground.

22. A method according to claim 17 wherein;
at least a first electrical contact to at least one of the first photodetector and the second photodetector is connected to one end of a variable resistance element.

23. A method according to claim 17 further comprising:
providing a correction circuit electrically connected to the first photodetector and second photodetector, the correction circuit for applying a correction signal to a first signal generated in dependence upon at least a first photocurrent generated within the first photodetector, the correction signal being generated in dependence upon at least a second photocurrent generated within the second photodetector.

24. A method according to claim 23 wherein;
applying the correction signal comprises applying a correction in dependence upon crosstalk within the device, the crosstalk being at least one of optical crosstalk from an optical emitter associated with the device, optical crosstalk from optical signals received at the optical input port, and electrical crosstalk between a first electrical circuit connected to an optical emitter associated with the device and a second electrical circuit connected to the first photodetector.
